(19) United States
(12) Patent Application Publication
(10) Pub. No.: US 2025/0273399 A1
(43) Pub. Date: Aug. 28, 2025

(54) MULTILAYER CERAMIC CAPACITOR

(71) Applicant: Murata Manufacturing Co., Ltd., Nagaokakyo-shi (JP)

(72) Inventor: Makoto NISHIKORI, Nagaokakyo-shi (JP)

(21) Appl. No.: 18/619,239

(22) Filed: Mar. 28, 2024

(30) Foreign Application Priority Data
Feb. 26, 2024 (JP) 2024-026271

(51) Int. Cl. H01G 4/30; H01G 4/008; H01G 4/012; H01G 4/12; H01G 4/232

(52) U.S. Cl. CPC H01G 4/30; H01G 4/2325; H01G 4/0085; H01G 4/012; H01G 4/1227; H01G 4/1236

(57) ABSTRACT

A multilayer ceramic capacitor includes a multilayer body including an outer layer interior portion, an outermost effective layer vicinity portion, a chip middle portion, and silicon oxide segregation regions. In a cross section of the multilayer body in a plane parallel or substantially parallel to a width direction and a height direction, a relationship of average cross section areas of the silicon oxide segregation regions in the respective portions is expressed as:
the outer layer interior portion<the chip middle portion<the outermost effective layer vicinity portion.

### CROSS REFERENCE TO RELATED APPLICATIONS

This application claims the benefit of priority to Japanese Patent Application No. 2024-026271 filed on Feb. 26, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

For example, the multilayer ceramic capacitor described in Japanese Unexamined Patent Application Publication No. 2001-237137 includes a capacitor body including a ceramic sintered body made of a dielectric material such as barium titanate. Such a capacitor body includes internal electrode layers each made of a noble metal material such as silver or a silver-palladium alloy, or a base metal material such as nickel with a ceramic layer functioning as a dielectric layer interposed therebetween. The internal electrode layers alternately extend toward one end surface and the other end surface of the capacitor body. The internal electrode layers extending toward the one end surface and the internal electrode layers extending toward the other end surface are electrically connected to a respective one of the external electrodes having different potentials.

The internal electrode layers of the multilayer capacitor described in Japanese Unexamined Patent Application Publication No. 2001-237137 are each made of a metal material, and the external electrodes are each made of a plurality of metal components including the same metal as that of the internal electrode layers or a metal capable of being alloyed with the metal of the internal electrode layers, and a glass component. The external electrodes are each bonded to a wiring board via an electrically conductive resin adhesive. The area occupation ratio of the metal component relative to the cross-sectional area of each of the external electrodes ranges from 60% to 95%. Thus, the multilayer capacitor described in Japanese Unexamined Patent Application Publication No. 2001-237137 can be mounted on the wiring board at low cost with high reliability without using solder.

Incidentally, in the general multilayer ceramic capacitor as described above, the adhesive force at the interface between the dielectric layer and the internal electrode layer may decrease due to firing of the ceramic element body or the like in the manufacturing process, and layer peeling occurs. The layer peeling indicates peeling between the layers of the multilayer ceramic capacitor and peeling in the layers. The layer peeling occurs in the vicinity of the boundary between the effective layer portion and the outer layer portion due to a difference in shrinkage behavior between the dielectric layer and the internal electrode layer during firing.

### SUMMARY OF THE INVENTION

Example embodiments of the present invention provide multilayer ceramic capacitors that are each able to reduce or prevent an occurrence of layer peeling.

An example embodiment of the present invention provides a multilayer ceramic capacitor that includes a multilayer body including a plurality of laminated dielectric layers and a plurality of laminated internal electrode layers, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an effective layer portion including the plurality of dielectric layers and the plurality of internal electrode layers that are alternately laminated, and outer layer portions that sandwich the effective layer portion in the height direction, a first external electrode on the first end surface, and a second external electrode on the second end surface, in which the multilayer body further includes an outer layer interior portion inside one of the outer layer portions, an outermost effective layer vicinity portion, which is closest to one of the outer layer portions, in the effective layer portion, a chip middle portion in a middle portion of the multilayer body, and a plurality of silicon oxide segregation regions, and in a cross section of the multilayer body in a plane parallel or substantially parallel to the width direction and the height direction, a relationship of average cross sectional areas of a plurality of silicon oxide segregation regions in respective portions of the outer layer interior portion, the chip middle portion, and the outermost effective layer vicinity portion is expressed as:
the outer layer interior portion<the chip middle portion<the outermost effective layer vicinity portion.

According to example embodiments of the present invention, it is possible to provide multilayer ceramic capacitors that are each able to reduce or prevent the occurrence of layer peeling.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment of the present invention.

FIG. 2 is a cross-sectional view taken along the line 101-101 of FIG. 1.

FIG. 3 is a cross-sectional view taken along the line 102-102 of FIG. 2.

FIG. 4 is a cross-sectional view taken along the line 103-103 of FIG. 2.

FIG. 5 is a cross-sectional view taken along the line 104-104 of FIG. 2.

FIG. 6 is a cross-sectional view taken along the line 105-105 of FIG. 2.

FIG. 7 is an enlarged view of an outer layer interior portion and an outermost effective layer vicinity portion.

FIG. 8 is an image showing a result of observing the outer layer interior portion and the outermost effective layer vicinity portion of a ceramic capacitor using an FE-WDX apparatus.

FIG. 9 is an image showing a result of observing a middle portion of a chip of the ceramic capacitor using the FE-WDX apparatus.

### DETAILED DESCRIPTION OF THE EXAMPLE EMBODIMENTS

Example embodiments of the present invention will be described below with reference to the drawings.

### Multilayer Ceramic Capacitor

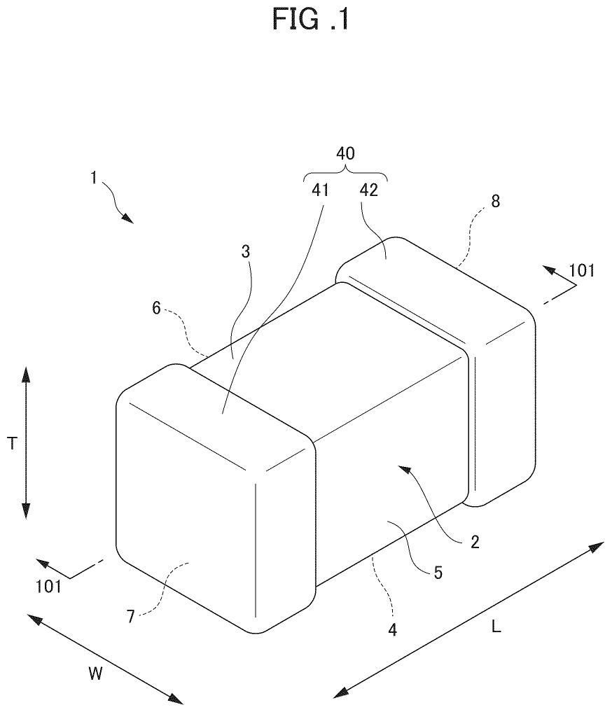

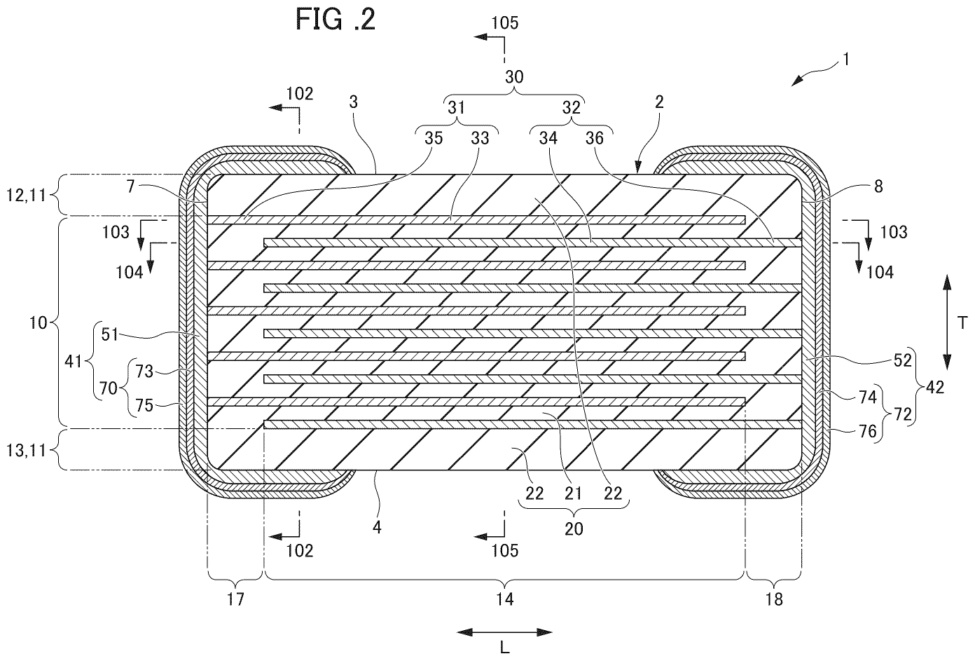

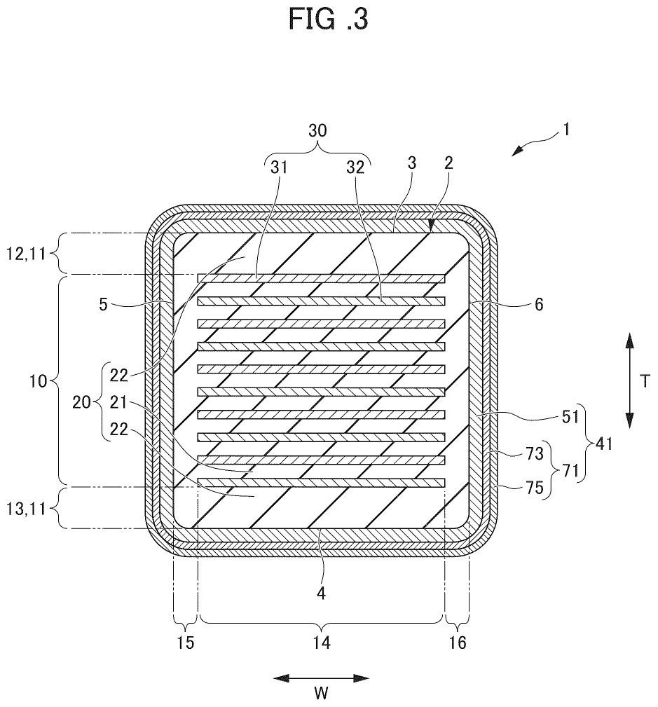

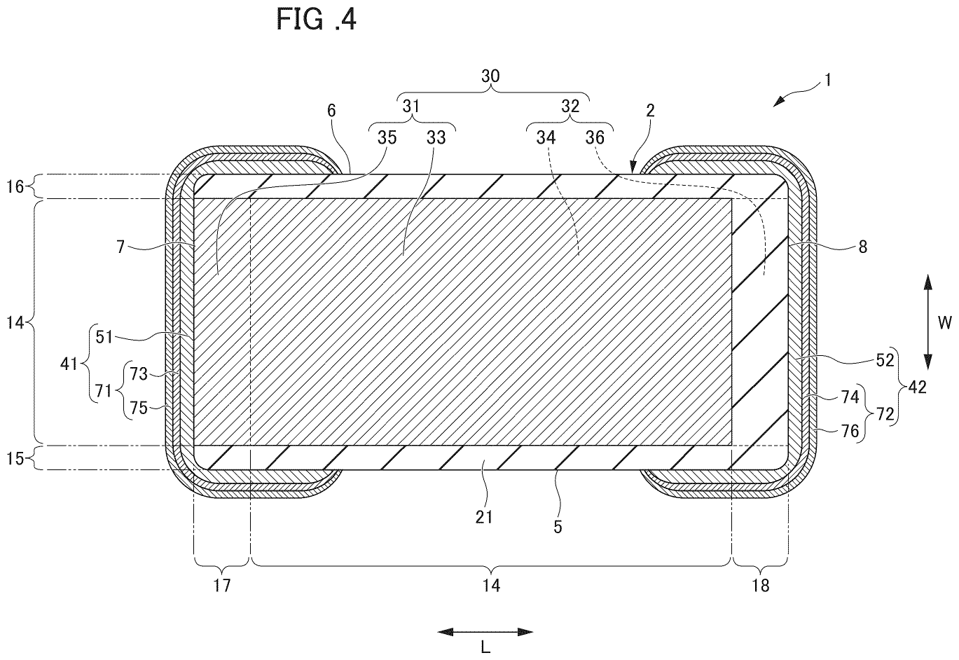

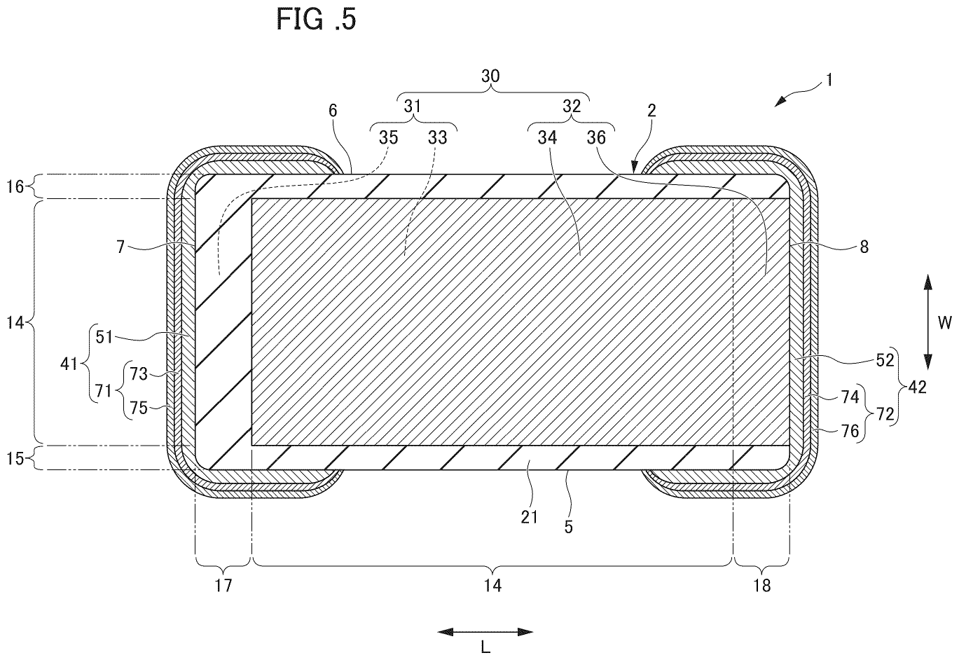

A multilayer ceramic capacitor 1 according to an example embodiment of the present invention will be described with reference to FIG. 1 to FIG. 5. FIG. 1 is an external perspective view of a multilayer ceramic capacitor 1 according to an example embodiment of the present invention. FIG. 2 is a cross-sectional view taken along the line 101-101 of FIG. 1. FIG. 3 is a cross-sectional view taken along the line 102-102 of FIG. 2. FIG. 4 is a cross-sectional view taken along the line 103-103 of FIG. 2. FIG. 5 is a cross-sectional view taken along the line 104-104 of FIG. 2.

As shown in FIG. 1, the multilayer ceramic capacitor 1 has a rectangular or substantially rectangular parallelepiped shape. The multilayer ceramic capacitor 1 includes a multilayer body 2 having a rectangular or substantially rectangular parallelepiped shape and a pair of external electrodes 40 spaced apart from each other at both end portions of the multilayer body 2.

In FIG. 1, an arrow T indicates a height direction of the multilayer ceramic capacitor 1 and the multilayer body 2. The height direction T also refers to a thickness direction and a lamination (stacking) direction of the multilayer ceramic capacitor 1 and the multilayer body 2. In FIG. 1, the arrow L indicates a length direction orthogonal or substantially orthogonal to the height direction T of the multilayer ceramic capacitor 1 and the multilayer body 2. In FIG. 1, the arrow W indicates a width direction orthogonal or substantially orthogonal to the height direction T and the length direction L of the multilayer ceramic capacitor 1 and the multilayer body 2. The pair of external electrodes 40 are respectively provided at one end and the other end of the multilayer body 2 in the length direction L.

The cross section shown in FIG. 2 is referred to as an LT cross section. The cross section shown in FIG. 3 is referred to as a WT cross section. The cross section shown in FIG. 4 and the cross section shown in FIG. 5 are referred to as LW cross sections.

### Multilayer Body

Two surfaces of the multilayer body 2 opposed to each other in the height direction T are referred to as a first main surface 3 and a second main surface 4. Two surfaces opposed to each other in the length direction L orthogonal or substantially orthogonal to the height direction T of the multilayer body are referred to as a first end surface 7 and a second end surface 8. Two surfaces opposed to each other in the width direction W orthogonal or substantially orthogonal to the height direction T and the length direction L of the multilayer body 2 are referred to as a first lateral surface 5 and a second lateral surface 6.

As shown in FIG. 1, the multilayer body 2 has a rectangular or substantially rectangular parallelepiped shape. The dimension in the length direction L of the multilayer body 2 may not be longer than the dimension in the width direction W. The shapes of the corner portions of the multilayer body 2 and the ridge portions of the multilayer body 2 are preferably rounded. Each of the corner portions is a portion where the three surfaces of the multilayer body intersect. Each of the ridge portions is a portion where two surfaces of the multilayer body intersect. A portion or the entirety of the surface of the multilayer body 2 may have unevenness or the like.

The size of the multilayer body 2 is not limited. For example, a dimension in the length direction L of the multilayer body 2 is preferably about 0.2 mm or more and about 6 mm or less. A dimension in the height direction T of the multilayer body 2 is preferably about 0.05 mm or more and about 5 mm or less. The dimension of the multilayer body 2 in the width direction W is preferably about 0.1 mm or more and about 5 mm or less.

### Segmentation in Height Direction

As shown in FIGS. 2 and 3, the multilayer body 2 is divided into an effective layer portion 10 and main surface-side outer layer portions 11 in the height direction T. The main surface-side outer layer portions 11 include a first main surface-side outer layer portion 12 and a second main surface-side outer layer portion 13. The first main surface-side outer layer portion 12 and the second main surface-side outer layer portion 13 sandwich the effective layer portion 10 in the height direction T. That is, the multilayer body 2 is divided into the first main surface-side outer layer portion 12, the effective layer portion 10, and the second main surface-side outer layer portion 13.

### Dielectric Layer

The effective layer portion 10 includes a plurality of dielectric layers 20 and a plurality of internal electrode layers 30 alternately laminated in the height direction T. The effective layer portion 10 includes the internal electrode layers 30 from an internal electrode layer 30 positioned closest to the first main surface 3 to an internal electrode layer 30 positioned closest to the second main surface 4 in the height direction T. In the effective layer portion 10, the plurality of internal electrode layers 30 are opposed to each other with the dielectric layer 20 interposed therebetween. The effective layer portion 10 is a portion that substantially defines and functions as a capacitor to generate capacitance. The dielectric layers 20 included in the effective layer portion 10 are referred to as inner dielectric layers 21. The dielectric layers 20 included in the first main surface-side outer layer portion 12 and the dielectric layers 20 included in the second main surface-side outer layer portion 13 are each referred to as an outer dielectric layer 22.

The plurality of dielectric layers 20 are made of a dielectric material. Examples of dielectric materials include dielectric ceramics that include components such as barium titanate, calcium titanate, strontium titanate, or calcium zirconate. The dielectric material may be obtained by adding a subcomponent such as a manganese compound, an iron compound, a copper compound, a cobalt compound, or a nickel compound to the main component. A preferable material of the dielectric material includes, for example, a material containing barium titanate as a main component.

The thickness of each of the dielectric layers 20 is preferably, for example, about 0.2 μm or more and about 10 μm or less. The number of the laminated dielectric layers 20 is preferably, for example, 15 or more and 1200 or less. The number of layers of the dielectric layer 20 is the sum of the number of the inner dielectric layers 21 and the number of the outer dielectric layers 22.

### Internal Electrode Layer

The plurality of internal electrode layers 30 includes a plurality of first internal electrode layers 31 and a plurality of second internal electrode layers 32. The first internal electrode layers 31 and the second internal electrode layers 32 are alternately provided in the height direction T with the dielectric layer 20 interposed therebetween. The first internal electrode layers 31 each extend toward the first end surface 7 and are exposed at the first end surface 7. The second internal electrode layers 32 each extend toward the second end surface 8 and are exposed at the second end surface 8.

As shown in FIG. 4, each of the first internal electrode layers 31 is divided into a first counter portion 33 and a first extension portion 35. Each of the first counter portions 33 is opposed to the second internal electrode layer 32 with the dielectric layer 20 interposed therebetween. Each of the first extension portions 35 extends from the first counter portion 33 toward the first end surface 7. The first extension portion 35 is exposed at the first end surface 7.

As shown in FIG. 5, each of the second internal electrode layers 32 is divided into a second counter portion 34 and a second extension portion 36. Each of the second counter portions 34 is opposed to the first internal electrode layer 31 with the dielectric layer 20 interposed therebetween. The second extension portion 36 extends from the second counter portion 34 toward the second end surface 8. The second extension portion 36 is exposed at the second end surface 8.

In the multilayer ceramic capacitor 1, the first counter portion 33 and the second counter portion 34 are opposed to each other with the dielectric layer 20 interposed therebetween, such that a capacitance is generated. With such a configuration, the characteristics of the capacitor are generated in the multilayer ceramic capacitor 1.

The shape of each of the first counter portions 33 and the second counter portions 34 is not limited. A preferable shape of each of the first counter portions 33 and the second counter portions 34 is a rectangular or substantially rectangular shape. Similarly, the shapes of each of the first extension portions 35 and the second extension portions 36 are not limited. A preferable shape of each of the first extension portions 35 and the second extension portions 36 is a rectangular or substantially rectangular shape. In the above-described rectangular or substantially rectangular shape, each of the rectangular or substantially rectangular corner portions may have a rounded shape. Each of the rectangular or substantially rectangular corner portions may have an oblique shape.

The length of each of the first counter portions 33 in the width direction W and the length of each of the first extension portion 35 in the width direction W may be the same or substantially the same. Either one of the length of each of the first counter portions 33 in the width direction W and the length of each of the first extension portions 35 in the width direction W may be shorter than the other. The length of each of the second counter portions 34 in the width direction W and the length of each of the second extension portions 36 in the width direction W may be the same or substantially the same. Either one of the length of each of the second counter portions 34 in the width direction W and the length of each of the second extension portions 36 in the width direction W may be shorter than the other.

Examples of the material of each of the first internal electrode layers 31 and the second internal electrode layers 32 include an electrically conductive material such as a metal such as nickel, copper, silver, palladium, or gold, or an alloy including at least one of these metals. When an alloy is used, examples of the material of each of the first internal electrode layers 31 and the second internal electrode layers 32 is an alloy of silver and palladium.

Examples of preferable thicknesses of each of the first internal electrode layers 31 and the second internal electrodes layer 32 are about 0.2 μm or more and about 2.0 μm or less. A preferable number of layers of the sum of the first internal electrode layers 31 and the second internal electrode layers 32 is, for example, 15 or more and 1000 or less.

### Main Surface-Side Outer Layer Portion

As shown in FIGS. 2 and 3, a portion of an aggregate of the plurality of dielectric layers 20 positioned between the first main surface 3 and the internal electrode layer 30 closest to the first main surface 3 is referred to as the first main surface-side outer layer portion 12. The first main surface-side outer layer portion 12 is adjacent to the first main surface 3 of the multilayer body 2. A portion of an aggregate of the plurality of dielectric layers 20 positioned between the second main surface 4 and the internal electrode layer 30 closest to the second main surface 4 is referred to as the second main surface-side outer layer portion 13. The second main surface-side outer layer portion 13 is adjacent to the second main surface 4 of the multilayer body 2. The dielectric layers 20 of the first main surface-side outer layer portion 12 and the second main surface-side outer layer portion 13 may be the same or substantially the same as the dielectric layers 20 of the effective layer portion 10. The material of the inner dielectric layers 21 and the material of the outer dielectric layers 22 may be the same.

### Electrode Counter Portion

A portion where the first counter portion 33 of each of the first internal electrode layers 31 and the second counter portion 34 of each of the second internal electrode layers 32 are opposed to each other is referred to as an electrode counter portion 14. The electrode counter portion 14 is a portion of the effective layer portion 10. FIGS. 4 and 5 each show the range of the electrode counter portion 14 in the width direction W and the length direction L. The electrode counter portion 14 is also referred to as a capacitor effective portion.

### Segmentation in Direction W

The multilayer body 2 is divided into a first lateral surface-side outer layer portion 15, the electrode counter portion 14, and a second lateral surface-side outer layer portion 16 in the width direction W. The first lateral surface-side outer layer portion 15 is a portion including the dielectric layers 20 positioned between the electrode counter portion 14 and the first lateral surface 5. The second lateral surface-side outer layer portion 16 is a portion including the dielectric layers 20 positioned between the electrode counter portion 14 and the second lateral surface 6. FIG. 3, FIG. 4, and FIG. 5 each show the ranges of the first lateral surface-side outer layer portion 15, the electrode counter portion 14, and the second lateral surface-side outer layer portion 16 in the width direction W. The first lateral surface-side outer layer portion 15 and the second lateral surface-side outer layer portion 16 are each referred to as a W gap or a side gap.

### Segmentation in Direction L

The multilayer body 2 is divided into a first end surface-side outer layer portion 17, the electrode counter portion 14, and a second end surface-side outer layer portion 18 in the length direction L. The first end surface-side outer layer portion 17 is a portion including the dielectric layers 20 and the first extension portions 35 positioned between the electrode counter portion 14 and the first end surface 7. The first end surface-side outer layer portion 17 is an aggregate of portions of the plurality of dielectric layers 20 adjacent to the first end surface 7 and the plurality of first extension portions 35. The second end surface-side outer layer portion 18 is a portion including the dielectric layers 20 and the second extension portion 36 positioned between the electrode counter portion 14 and the second end surface 8. The second end surface-side outer layer portion 18 is an aggregate of portions of the plurality of dielectric layers 20 adjacent to the second end surface 8 and the plurality of second extension portions 36. FIG. 2, FIG. 4, and FIG. 5 each show the ranges of the first end surface-side outer layer portion 17, the electrode counter portion 14, and the second end surface-side outer layer portion 18 in the length direction L. The first end surface-side outer layer portion 17 and the second end surface-side outer layer portion 18 are each referred to as an L gap or an end gap.

### External Electrode

The external electrodes 40 include a first external electrode 41 and a second external electrode 42. The first external electrode 41 is on the first end surface 7 of the multilayer body 2. The second external electrode 42 is on the second end surface 8 side of the multilayer body 2.

The basic configurations of the first external electrode 41 and the second external electrode 42 are the same. The first external electrode 41 and the second external electrode 42 have a plane symmetrical shape or a substantially plane symmetrical shape with respect to the WT cross section at the center in the length direction L of the multilayer ceramic capacitor 1.

The first external electrode 41 is on the first end surface 7. The first external electrode 41 contacts the first extension portion 35 of each of the plurality of first internal electrode layers 31 exposed at the first end surface 7. The first external electrode 41 is electrically connected to each of the plurality of first internal electrode layers 31. The first external electrode 41 may also be provided on a portion of the first main surface 3 and a portion of the second main surface 4, and also on a portion of the first lateral surface 5 and a portion of the second lateral surface 6. In the present example embodiment, the first external electrode 41 extends from the first end surface 7 to a portion of the first main surface 3 and a portion of the second main surface 4, and to a portion of the first lateral surface 5 and a portion of the second lateral surface 6.

The second external electrode 42 is on the second end surface 8. The second external electrode 42 contacts the second extension portion 36 of each of the plurality of second internal electrode layers 32 exposed at the second end surface 8. The second external electrode 42 is electrically connected to each of the plurality of second internal electrode layers 32. The second external electrode 42 may also be provided on a portion of the first main surface 3 and a portion of the second main surface 4, and also on a portion of the first lateral surface 5 and a portion of the second lateral surface 6. In the present example embodiment, the second external electrode 42 extends from the second end surface 8 to a portion of the first main surface 3 and a portion of the second main surface 4, and to a portion of the first lateral surface 5 and a portion of the second lateral surface 6.

In the multilayer body 2, the first counter portion 33 of each of the first internal electrode layers 31 and the second counter portion 34 of each of the second internal electrode layers 32 are opposed to each other with the dielectric layer 20 interposed therebetween, such that a capacitance is generated. Therefore, the characteristic of the capacitor is generated between the first external electrode 41 to which the plurality of first internal electrodes layer 31 are connected and the second external electrode 42 to which the plurality of second internal electrode layers 32 are connected.

### Base Electrode Layer

As shown in FIGS. 2, 4, and 5, the first external electrode 41 includes a first base electrode layer 51 and a first plated layer 71. The first plated layer 71 is on the first base electrode layer 51. The second external electrode 42 includes a second base electrode layer 52 and a second plated layer 72. The second plated layer 72 is on the second base electrode layer 52.

The first base electrode layer 51 is on the first end surface 7. The first base electrode layer 51 contacts the first extension portion 35 of each of the plurality of first internal electrode layers 31 exposed at the first end surface 7. The first base electrode layer 51 extends from the first end surface 7 to a portion of the first main surface 3 and a portion of the second main surface 4, and to a portion of the first lateral surface 5 and a portion of the second lateral surface 6.

The second base electrode layer 52 is on the second end surface 8. The second base electrode layer 52 contacts the second extension portion 36 of each of the plurality of second internal electrode layers 32 exposed at the second end surface 8. The second base electrode layer 52 extends from the second end surface 8 to a portion of the first main surface 3 and a portion of the second main surface 4, and to a portion of the first lateral surface 5 and a portion of the second lateral surface 6.

Each of the first base electrode layer 51 and the second base electrode layer 52 is, for example, a fired layer. The fired layer preferably includes a metal component. The fired layer preferably includes, for example, at least one of a glass component or a ceramic component in addition to a metal component. The metal component includes, for example, at least one of copper, nickel, silver, palladium, an alloy of silver and palladium, gold, and the like. The glass component includes, for example, at least one of boron, silicon, barium, magnesium, aluminum, lithium, and the like. The ceramic component may be a ceramic material the same as or similar to the dielectric layers 20. The ceramic component may be a ceramic material different from the dielectric layers 20. The ceramic component includes, for example, at least one of barium titanate, calcium titanate, a mixed crystal material obtained by replacing a portion of the barium of barium titanate with calcium, strontium titanate, calcium zirconate, and the like.

Examples of the fired layer include a layer formed by coating a multilayer body with an electrically conductive paste including glass and metal, and firing the resultant product. The fired layer is formed by simultaneously firing a multilayer chip before firing, which is a material of a multilayer body including a plurality of internal electrode layers and a plurality of dielectric layers, and an electrically conductive paste applied to the multilayer chip. Alternatively, the fired layer is formed by firing a multilayer chip to obtain a multilayer body, then applying an electrically conductive paste to the multilayer body, and firing the resultant product. In a case in which the electrically conductive paste is fired after the multilayer body is obtained, the fired layer is preferably formed by firing the electrically conductive paste to which a ceramic material is added instead of the glass component. When an electrically conductive paste to which a ceramic material is added is used, the ceramic material to be added is preferably a ceramic material of the same kind as the dielectric layer. The fired layer may include a plurality of layers.

An example of a preferable thickness in the length direction L of the first base electrode layer 51 on the first end surface 7 is, for example, about 10 μm or more and about 200 μm or less in the middle portion in the height direction T and the width direction W of the first base electrode layer 51.

An example of a preferable thickness in the length direction L of the second base electrode layer 52 on the second end surface 8, for example, is about 10 μm or more and about 200 μm or less in the middle portion in the height direction T and the width direction W of the second base electrode layer 52.

In a case where the first base electrode layer 51 is also provided on a portion of at least one of the first main surface 3 or the second main surface 4, an example of a preferable thickness in the height direction T of the first base electrode layer 51 provided on this portion is about 3 μm or more and about 40 μm or less in the middle portion in the length direction L and the width direction W of the first base electrode layer 51 provided on this portion.

In a case where the first base electrode layer 51 is also provided on a portion of at least one of the first lateral surface 5 or the second lateral surface 6, an example of a preferable thickness in the width direction W of the first base electrode layer 51 provided on this portion is about 3 μm or more and about 40 μm or less in the middle in the length direction L and the height direction T of the first base electrode layer 51 provided on this portion.

In a case where the second base electrode layer 52 is also provided on a portion of at least one of the first main surface 3 or the second main surface 4, an example of a preferable thickness in the height direction T of the second base electrode layer 52 provided on this portion is about 3 μm or more and about 40 μm or less in the middle in the length direction L and the width direction W of the second base electrode layer 52 provided on this portion.

In a case where the second base electrode layer 52 is also provided on a portion of at least one of the first lateral surface 5 or the second lateral surface 6, an example of a preferable thickness of the second base electrode layer 52 in the width direction W provided on this portion is about 3 μm or more and about 40 μm or less in the middle of the second base electrode layer 52 in the length direction L and the height direction T provided on this portion.

The first plated layer 71 covers the first base electrode layer 51. The second plated layer 72 covers the second base electrode layer 52.

The first plated layer 71 and the second plated layer 72 may include, for example, at least one of copper, nickel, tin, silver, palladium, an alloy of silver and palladium, gold, and the like. Each of the first plated layer 71 and the second plated layer 72 may include a plurality of layers. A preferable configuration of the first plated layer 71 and the second plated layer 72 is, for example, a two-layer configuration in which a tin plated layer is provided on a nickel plated layer.

The first plated layer 71 covers the first base electrode layer 51. In the present example embodiment, the first plated layer 71 includes a first nickel plated layer 73 and a first tin plated layer 75. The first tin plated layer 75 is on the first nickel plated layer 73.

The second plated layer 72 covers the second base electrode layer 52. In the present example embodiment, the second plated layer 72 includes a second nickel plated layer 74 and a second tin plated layer 76. The second tin plated layer 76 is on the second nickel plated layer 74.

The nickel plated layer reduces or prevents the erosion of the first base electrode layer 51 and the second base electrode layer 52 by solder when the multilayer ceramic capacitor 1 is mounted. The tin plated layer improves wettability of solder when the multilayer ceramic capacitor 1 is mounted. The tin plated layer facilitates mounting of the multilayer ceramic capacitor 1. The thickness of each of the first nickel plated layer 73, the first tin plated layer 75, the second nickel plated layer 74, and the second tin plated layer 76 is preferably, for example, about 2 μm or more and about 10 μm or less.

Each of the external electrodes 40 may include an electrically conductive resin layer including, for example, electrically conductive particles and a thermosetting resin. When each of the external electrodes 40 includes an electrically conductive resin layer, the electrically conductive resin layer may cover the fired layer. When the electrically conductive resin layer covers the fired layer, the electrically conductive resin layer is provided between the fired layer and the plated layer. The fired layer corresponds to the first base electrode layer 51 and the second base electrode layer 52. The plated layer corresponds to the first plated layer 71 and the second plated layer 72. The electrically conductive resin layer may completely cover the fired layer. The electrically conductive resin layer may cover a portion of the fired layer.

The electrically conductive resin layer including a thermosetting resin is more flexible than an electrically conductive layer including a plating film or a fired product of an electrically conductive paste. Therefore, when a physical impact or an impact caused by a thermal cycle is applied to the multilayer ceramic capacitor, the electrically conductive resin layer defines and functions as a buffer layer. Therefore, the electrically conductive resin layer reduces or prevents the generation of cracks in the multilayer ceramic capacitor.

Examples of metals of the electrically conductive particles include silver, copper, nickel, tin, bismuth, and alloys including at least two of these metals. The electrically conductive particles preferably include silver. Examples of conductive particles include silver metal powder. Silver has the lowest specific resistance among metals. Silver is suitable for electrode materials. Silver is a noble metal. Silver is difficult to oxidize. Silver has high weatherability. For these reasons, silver metal powder is suitable as conductive particles.

The electrically conductive particles may be silver-coated metal powders. When conductive particles whose surface is silver-coated are used, the metal powder is preferably, for example, a powder of copper, nickel, tin, bismuth, or an alloy thereof. It is preferable to use silver-coated metal powder to maintain silver characteristics and make the metal of the base material inexpensive.

The electrically conductive particles may be provided by, for example, subjecting copper or nickel to an antioxidant treatment. The electrically conductive particles may be, for example, metal powder in which the surface of the metal powder is coated with tin, nickel, or copper. When a metal powder coated with tin, nickel, or copper is used on the surface of the metal powder, the metal powder is preferably, for example, silver, copper, nickel, tin, bismuth, or an alloy powder including at least two of these metals.

The shape of the electrically conductive particles is not limited. Examples of the shape of the electrically conductive particles include a spherical shape and a flat shape. It is preferable to use a mixture of spherical metal powder and flat metal powder.

The electrically conductive particles included in the electrically conductive resin layer mainly ensure the electrical conductivity of the electrically conductive resin layer. When the plurality of conductive particles are brought into contact with each other, an energizing path is provided inside the electrically conductive resin layer.

Examples of the resin of the electrically conductive resin layer may include at least one of various known thermosetting resins such as epoxy resin, phenol resin, urethane resin, silicone resin, and polyimide resin. Among them, an epoxy resin is one of the most suitable resins. The epoxy resin is excellent in heat resistance, moisture resistance, adhesiveness, and the like. The resin of the electrically conductive resin layer preferably includes, for example, a curing agent together with the thermosetting resin. When an epoxy resin is used as the base resin, the curing agent of the epoxy resin may be any of various known compounds such as, for example, phenolic, amine-based, acid anhydride-based, imidazole-based, active ester-based, and amideimide-based compounds.

The electrically conductive resin layer may include a plurality of layers. The thickness of the thickest portion of the electrically conductive resin layer is preferably, for example, about 10 μm or more and about 150 μm or less.

The basic configuration of the multilayer ceramic capacitor 1 is described above. For example, the preferable dimension in the length direction L of the multilayer ceramic capacitor 1 including the multilayer body 2 and the external electrode 40 is about 0.2 mm or more and about 6 mm or less. The preferable dimension in the height direction T of the multilayer ceramic capacitor 1 is about 0.05 mm or more and about 5 mm or less. The preferable dimension in the width direction W of the multilayer ceramic capacitor 1 is about 0.1 mm or more and about 5 mm or less.

### Segregation of Silicon Oxide

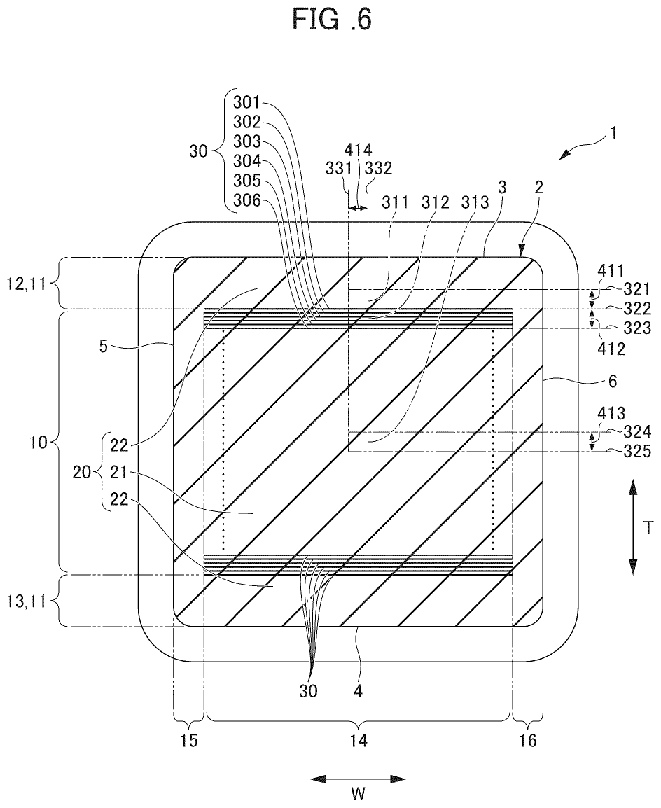

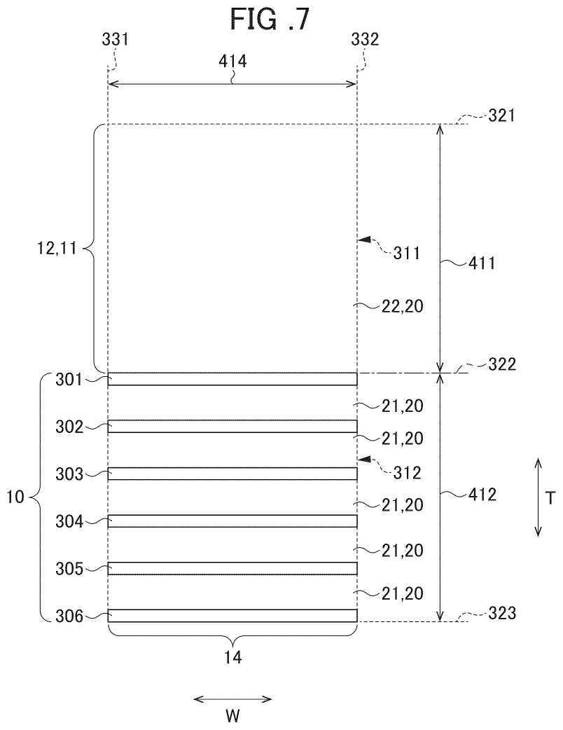

In the multilayer ceramic capacitor 1 of the present example embodiment, silicon oxide segregates inside the multilayer body 2. Further, the silicon oxide does not segregate uniformly in the multilayer body 2. A description will be provided with reference to FIGS. 6 and 7. FIG. 6 is a cross-sectional view taken along the line 105-105 of FIG. 2. FIG. 6 shows a WT cross section in the middle portion in the length direction L. In FIG. 6, the internal electrode layers 30 are each simplified as a line segment parallel to the width direction W.

Outer Layer Interior Portion, Outermost Effective Layer Vicinity Portion, and Chip Middle portion

An enclosure 311 shown in FIG. 6 shows an outer layer interior portion 311. An enclosure 312 shows an outermost effective layer vicinity portion 312. An enclosure 313 shows a chip middle portion 313. The outer layer interior portion 311, the outermost effective layer vicinity portion 312, and the chip middle portion 313 are evaluation regions to evaluate segregation of silicon oxide. In the following description, an evaluation portion indicates the outer layer interior portion 311, the outermost effective layer vicinity portion 312, and the chip middle portion 313. The evaluation portion is in the WT cross section in the middle portion in the length direction L of the multilayer ceramic capacitor 1. The shape of the evaluation portion is square or substantially square. The two sides of the evaluation portion are parallel or substantially parallel to the width direction W. The remaining two sides of the evaluation portion are parallel or substantially parallel to the height direction T. The outer layer interior portion 311, the outermost effective layer vicinity portion 312, and the chip middle portion 313 have the same or substantially the same size.

### Size of Evaluation Portion, Outermost Effective Layer Vicinity Portion

The size of the evaluation portion will be described with reference to the outermost effective layer vicinity portion 312. In the following description, FIG. 7 is referred to in addition to FIG. 6. FIG. 7 is an enlarged view of the outer layer interior portion 311 and the outermost effective layer vicinity portion 312.

The outermost effective layer vicinity portion 312 is a vicinity portion of a boundary of the effective layer portion 10 with the main surface-side outer layer portion 11. The range in the height direction T of the outermost effective layer vicinity portion 312 is a range of five layers of the internal electrode layer 30 from the internal electrode layer 30 closest to the main surface toward the inside of the multilayer body 2. The outermost effective layer vicinity portion 312 shown in FIG. 6 is positioned at a boundary between the first main surface-side outer layer portion 12 and the effective layer portion 10. The internal electrode layer 30 closest to the first main surface 3 is an internal electrode layer 301. The internal electrode layer 30 of the fifth layer in the direction from the internal electrode layer 301 to the inside of the multilayer body 2 is an internal electrode layer 306. Between the internal electrode layers 301 and 306, there are four internal electrode layers 30 from the internal electrode layer 302 to the internal electrode layer 305.

The range in the height direction T of the outermost effective layer vicinity portion 312 is from the line 322 to the line 323. The range from line 322 to line 323 includes five inner dielectric layers 21.

The position of the outermost effective layer vicinity portion 312 in the width direction W is in the middle position of the multilayer body 2 in the width direction W. The length of the outermost effective layer vicinity portion 312 in the width direction W is the same or substantially the same as the length of the outermost effective layer vicinity portion 312 in the height direction T. The shape of the outermost effective layer vicinity portion 312 is square or substantially square. Extension lines of the sides parallel or substantially parallel to the width direction W of the outermost effective layer vicinity portion 312 are denoted by a line 322 and a line 323. A distance in the height direction T from the line 322 to the line 323 is referred to as a distance 412. Extension lines of the sides parallel or substantially parallel to the height direction T of the outermost effective layer vicinity portion 312 are denoted by a line 331 and a line 332. The distance in the width direction W from the line 331 to the line 332 is referred to as a distance 414. The distance 414 is equal or substantially equal to the distance 412.

### Outer Layer Interior Portion

Next, the outer layer interior portion 311 will be described. The outer layer interior portion 311 is inside the main surface-side outer layer portion 11. The shape and size of the outer layer interior portion 311 are the same or substantially the same as the shape and size of the outermost effective layer vicinity portion 312.

The position of the outer layer interior portion 311 in the width direction W is the same or substantially the same as the position of the outermost effective layer vicinity portion 312 in the width direction W. The outer layer interior portion 311 is in the middle of the multilayer body 2 in the width direction W.

Two sides parallel or substantially parallel to the height direction T of the outer layer interior portion 311 are on the line 331 and the line 332. The length of the outer layer interior portion 311 in the width direction W is the same or substantially the same as the length of the outermost effective layer vicinity portion 312 in the width direction W.

The range in the height direction T of the outer layer interior portion 311 is from the boundary between the effective layer portion 10 and the main surface-side outer layer portion 11 to a position separated by a predetermined distance in the direction of the main surface adjacent to the boundary. The predetermined distance is equal or substantially equal to the length of the outermost effective layer vicinity portion 312 in the height direction T.

An extension line of a side parallel or substantially parallel to the width direction W of the outer layer interior portion 311 is denoted by a line 321 and a line 322. One side of the two sides parallel or substantially parallel to the width direction W of the outer layer interior portion 311 is common to one side of the two sides parallel or substantially parallel to the width direction W of the outermost effective layer vicinity portion 312. In the example shown in FIG. 7, the line 322 is a common line. The distance in the height direction T from the line 322 to the line 321 is referred to as the distance 411. The distance 411 is equal or substantially equal to the distance 412.

### Chip Middle Portion

Next, the chip middle portion 313 will be described. The chip middle portion 313 is in the middle portion of the multilayer body 2. The shape and size of the chip middle portion 313 are the same or substantially the same as the shape and size of the outermost effective layer vicinity portion 312.

The position of the chip middle portion 313 in the width direction W is the same or substantially the same as the position of the outermost effective layer vicinity portion 312 in the width direction W. The position of the chip middle portion 313 in the width direction W is in the middle position of the multilayer body 2 in the width direction W.

Two sides parallel or substantially parallel to the height direction T of the chip middle portion 313 are on the line 331 and the line 332. The length of the chip middle portion 313 in the width direction W is the same or substantially the same as the length of the outermost effective layer vicinity portion 312 in the width direction W.

The position of the chip middle portion 313 in the height direction T is in the middle position of the multilayer body 2 in the height direction T. Extension lines of the sides parallel or substantially parallel to the width direction W of the chip middle portion 313 are denoted by a line 324 and a line 325. The distance in the height direction T from the line 324 to the line 325 is referred to as a distance 413. The distance 413 is equal or substantially equal to the distance 412. The length of the chip middle portion 313 in the height direction T is the same or substantially the same as the length of the outermost effective layer vicinity portion 312 in the height direction T.

### Silicon Oxide Segregation Region

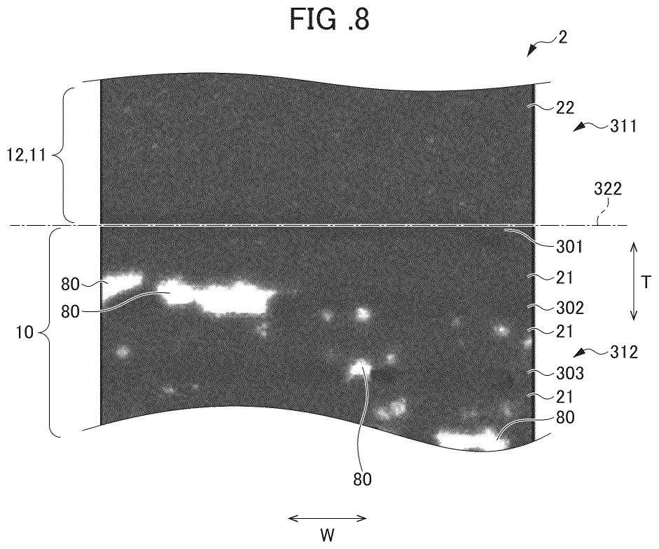

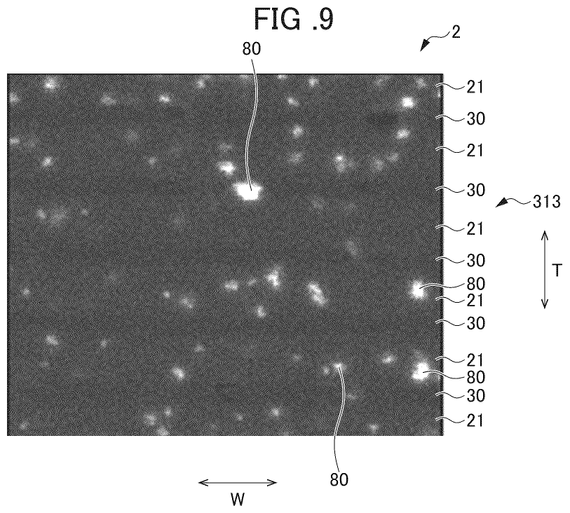

A region where silicon oxide segregates is referred to as a silicon oxide segregation region 80. The silicon oxide segregation region 80 is shown in FIGS. 8 and 9 described later.

### Measurement of Silicon Oxide Segregation

First, an example of a method of measuring segregation of silicon oxide will be described. The segregation of silicon oxide can be measured by field emission wavelength dispersion X-ray analysis (FE-WDX (Field-Emission Wavelength-Dispersive x-ray Spectroscopy)). The measurement conditions are as follows.

### Measurement Conditions

Measurement device: FE-WDX Apparatus
Acceleration voltage: about 15.0 eV
Irradiation current: about 5×10⁻⁸ A
Field of view: about 10 μm×about 10 μm
Number of pixels: 256×256
Pixel size: about 0.0782 (5000 times)
Dwell time (import time in one pixel): about 40 ms
Scan method: Beam
Depth of analysis: about 1 μm or more and about 2 μm or less

### Definition of Silicon Oxide Segregation Region

The amount of segregation, i.e., the degree of segregation, was evaluated by cps (count per second), which is the number of X-ray photons per unit time in the FE-WDX apparatus. A region in which the number of X-ray photons per unit time is about 100 cps or more was defined as a silicon oxide segregation region.

### Average Cross-sectional Area of Silicon Oxide Segregation Region

In the multilayer ceramic capacitor 1 of the present example embodiment, in the silicon oxide segregation region 80, the segregation is not uniform inside the multilayer body 2. First, the average cross-sectional area of the silicon oxide segregation region 80 will be described. In the multilayer ceramic capacitor 1 of the present example embodiment, the average cross-sectional area of the silicon oxide segregation region 80 in the WT cross section is expressed in the following order. Outer layer interior portion 311<Chip middle portion 313<Outermost effective layer vicinity portion 312.

The above expression indicates that the average cross-sectional area of the silicon oxide segregation region 80 in the chip middle portion 313 is larger than the average cross-sectional area of the silicon oxide segregation region 80 in the outer layer interior portion 311, and the average cross-sectional area of the silicon oxide segregation region 80 in the outermost effective layer vicinity portion 312 is larger than the average cross-sectional area of the silicon oxide segregation region 80 in the chip middle portion 313. When the average cross-sectional area of the silicon oxide segregation region 80 in the WT cross section satisfies the above order, the adhesive force between the dielectric layers 20 of the effective layer portion 10 or the interfaces between the internal electrode layers 30 of the effective layer portion 10 and the main surface-side outer layer portions 11 can be improved. As a result, the generation of layer peeling between the dielectric layers 20 and between the dielectric layers 20 and the internal electrode layers 30 can be reduced or prevented. A description thereof will be provided below in order. In addition, it is preferable that at least the average cross-sectional area of the silicon oxide segregation region 80 in the outermost effective layer vicinity portion 312 is larger than the average cross-sectional area of the silicon oxide segregation region 80 in the chip middle portion 313.

Observation Result with FE-WDX Apparatus

The silicon oxide segregation region 80 will be described with reference to FIGS. 8 and 9. FIG. 8 and FIG. 9 each show the result of observing the WT cross section in the middle portion in the length direction L of the ceramic capacitor 1 using the FE-WDX apparatus. FIG. 8 shows a portion of the outer layer interior portion 311 and a portion of the outermost effective layer vicinity portion 312. FIG. 9 shows the chip middle portion 313. In FIGS. 8 and 9, each of the portions which appears as a white lump indicates the silicon oxide segregation region 80. In FIGS. 8 and 9, not all the silicon oxide segregation regions 80 are denoted by reference numerals. Reference numerals are given to the silicon oxide segregation region 80 having large area.

### Outermost Effective Layer Vicinity Portion

As shown in FIG. 8, a plurality of silicon oxide segregation regions 80 having a large area are observed in the outermost effective layer vicinity portion 312. As shown in FIG. 9, a plurality of silicon oxide segregation regions 80 are observed also in the chip middle portion 313. However, the area of one silicon oxide segregation region 80 observed in the chip middle portion 313 is generally smaller than the area of one silicon oxide segregation region 80 observed in the outermost effective layer vicinity portion 312.

On the other hand, as shown in FIG. 8, the silicon oxide segregation region 80 is hardly observed in the outer layer interior portion 311. Although it is difficult to confirm in FIG. 8, a plurality of silicon oxide segregation regions 80 are also present in the inner portion 311 of the outer layer, and the area of these silicon oxide segregation regions 80 is extremely small.

As described above, the relationship of the average cross-sectional areas of the plurality of silicon oxide segregation regions 80 in the respective portions of the outer layer interior portion 311, the outermost effective layer vicinity portion 312, and the chip middle portion 313 in the cross section of the multilayer body 2 in the plane parallel or substantially parallel to the width direction W and the height direction T is expressed as follows: the outer layer interior portion 311<the chip middle portion 313<the outermost effective layer vicinity portion 312.

In the multilayer ceramic capacitor 1 of the present example embodiment, silicon oxide having a large cross-sectional area exists in the outermost effective layer vicinity portion 312, in other words, in the outermost portion of the effective layer portion 10. Therefore, the adhesive force between the effective layer portion 10 and the main surface-side outer layer portion 11 is improved, and the generation of layer peeling between the effective layer portion 10 and the main surface-side outer layer portion 11 can be reduced or prevented.

In particular, in the outermost effective layer vicinity portion 312, the silicon oxide segregation region 80 is likely to exist in the cuts of the internal electrode layer 30. As shown in FIG. 8, silicon oxide having large cross-sectional area exists in the internal electrode layer 30 in the region adjacent to the main surface-side outer layer portion 11.

The dielectric layer (ceramic layers) 20 including oxide and the internal electrode layer 30 including metal generally have weak adhesive force. When voids such as cuts exist in the internal electrode layer 30, the same oxide as the dielectric layer 20 exists in the voids, and particularly when the cross-sectional area of the oxide is large, the adhesive force strength between the dielectric layer 20 and the internal electrode layer 30 is improved.

When an oxide having large cross-sectional area is provided in the internal electrode layer 30, the contact area between the internal electrode layer 30 and the layer in contact with the internal electrode layer 30 increases. Therefore, the adhesive force between the internal electrode layer 30 and the layer in contact with the internal electrode layer 30 is improved.

Further, as described above, the oxide has stronger adhesive force to the ceramic layer than the metal. Therefore, the silicon oxide segregation region 80, which is present in the internal electrode layer 30 at a cut or the like and has large cross-sectional area and is integral with the metal of the internal electrode layer 30, can improve the adhesive force between the internal electrode layer 30 and the dielectric layer 20 in contact with the internal electrode layer 30.

As described above, in the multilayer ceramic capacitor 1 of the present example embodiment, the layer peeling between the effective layer portion 10 and the main surface-side outer layer portion 11 is reduced or prevented.

The cross-sectional shape of the silicon oxide segregation region 80 is preferably longer in the width direction W than in the height direction T. With such a configuration, it is possible to further improve the adhesive force between the internal electrode layer 30 and the dielectric layer 20 in the outermost effective layer vicinity portion 312, and the adhesive force between the effective layer portion 10 and the main surface-side outer layer portion 11.

### Chip Middle Portion

In the multilayer ceramic capacitor 1 of the present example embodiment, as shown in FIG. 9, the chip middle portion 313 also includes the silicon oxide having the cross-sectional area which is smaller than that in the outermost effective layer vicinity portion 312, but larger than that in the outer layer interior portion 311. Therefore, also in the middle portion of the effective layer portion 10, it is possible to reduce or prevent the layer peeling within the dielectric layer 20 and between the internal electrode layer 30 and the dielectric layer 20.

A preferable average cross-sectional area of the silicon oxide segregation region 80 will be described.

### Average Cross-Sectional Area of Silicon Oxide Segregation Region

A preferable average cross-sectional area of the silicon oxide segregation region 80 in the outermost effective layer vicinity portion 312 is, for example, about 0.50 μm² or more and about 1.20 μm² or less. A preferable average cross-sectional area of the silicon oxide segregation region 80 of the chip middle portion 313 is, for example, about 0.10 μm² or more and about 0.25 μm² or less. A preferable average cross-sectional area of the silicon oxide segregation region 80 in the outer layer interior portion 311 is, for example, about 0.05 μm² or less.

### Silicon Oxide Segregation Region in Outermost Effective Layer Region

When the average cross-sectional area of the silicon oxide segregation region 80 of the outermost effective layer vicinity portion 312 is less than about 0.50 μm², the adhesive force between the internal electrode layer 30 closest to the main surface-side outer layer portion 11 and the outer dielectric layer 22 of the main surface-side outer layer portion 11 in the effective layer portion 10 is insufficient. As a result, layer peeling tends to occur between the effective layer portion 10 and the main surface-side outer layer portion 11.

On the other hand, when the average cross-sectional area of the silicon oxide segregation region 80 of the outermost effective layer vicinity portion 312 is larger than about 1.20 μm², the proportion of silicon to the thickness of the dielectric layer 20 increases. As the proportion of silicon increases, the rare earth component relatively decreases. As a result, the high-temperature reliability of the multilayer ceramic capacitor 1 decreases.

### Silicon Oxide Segregation Region in Chip Middle Portion

When the average cross-sectional area of the silicon oxide segregation region 80 in the chip middle portion 313 is less than about 0.10 μm², the capacitance of the multilayer ceramic capacitor 1 decreases. Silicon has a low relative permittivity. Therefore, when silicon exists at the interface of the dielectric particles, the permittivity of the dielectric layer decreases. The small average cross-sectional area of the silicon oxide segregation region 80 indicates that a large amount of silicon that is not segregated exists at the interface of the dielectric particles.

When the average cross-sectional area of the silicon oxide segregation region 80 of the chip middle portion 313 is less than about 0.10 μm², a large amount of silicon exists at the interface of the dielectric particles, and as a result, the capacitance of the multilayer ceramic capacitor 1 decreases.

More specifically, the small average cross-sectional area of the silicon oxide segregation region 80 in the chip middle portion 313 indicates that, for example, silicon in the dielectric layer 20 is not discharged into the hole of the internal electrode layer 30 and is not segregated, but remains in the dielectric layer 20. When silicon is not discharged into the hole of the internal electrode layer 30 and remains inside the dielectric layer 20, the permittivity of the dielectric layer 20 itself decreases. This is because the permittivity of silicon is low. As a result, the capacitance of the multilayer ceramic capacitor 1 decreases. On the other hand, when silicon in the dielectric layer 20 is discharged into the hole of the internal electrode layer 30 and segregated, silicon in the dielectric layer 20 decreases and the capacitance increases.

On the other hand, when the average cross-sectional area of the silicon oxide segregation region 80 of the chip middle portion 313 is larger than about 0.25 μm², the high-temperature reliability of the multilayer ceramic capacitor 1 is reduced. When the segregation of silicon is large with respect to the thickness of the dielectric layer 20 in the height direction T, the rare earth component contained in the dielectric layer 20 becomes relatively small. Therefore, the high-temperature reliability of the multilayer ceramic capacitor 1 decreases.

### Silicon Oxide Segregation Region in Outer Layer Interior Portion

When the average cross-sectional area of the silicon oxide segregation region 80 in the outer layer interior portion 311 is larger than about 0.05 μm², the mechanical strength of the multilayer ceramic capacitor 1 decreases.

Preferable examples of the average cross-sectional areas of the silicon oxide segregation region 80 in the outermost effective layer vicinity portion 312, the chip middle portion 313, and the outer layer interior portion 311 are respectively about 0.859 μm², about 0.180 μm², and about 0.02 μm².

### Area Equivalent Diameter D90

The area equivalent diameter D90 of the silicon oxide segregation region 80 will be described. The area equivalent diameter D90 indicates an area equivalent diameter having a cumulative value of about 90% in the cumulative distribution of the area equivalent diameters of the plurality of silicon oxide segregation regions 80 observed. The area equivalent diameter D90 can be obtained from a cross-sectional observation result of the FE-WDX apparatus.

In the multilayer ceramic capacitor 1 of the present example embodiment, the relationship of the values of the area equivalent diameter D90 of the plurality of silicon oxide segregation regions 80 in the respective portions is expressed as the outer layer interior portion 311<the chip middle portion 313<the outermost effective layer vicinity portion 312.

The above expression indicates that the area equivalent diameter D90 of the silicon oxide segregation region 80 in the chip middle portion 313 is larger than the area equivalent diameter D90 of the silicon oxide segregation region 80 in the outer layer interior portion 311, and the area equivalent diameter D90 of the silicon oxide segregation region 80 in the outermost effective layer vicinity portion 312 is larger than the area equivalent diameter D90 of the silicon oxide segregation region 80 in the chip middle portion 313. The value of the area equivalent diameter D90 of each portion having the above-described relationship indicates that the relatively large silicon oxide segregation region 80 satisfies the above-described size relationship. Therefore, it is possible to further reduce or prevent the occurrence of layer peeling between the dielectric layer 20 and the internal electrode layer 30. It is preferable that at least the area equivalent diameter D90 of the silicon oxide segregation region 80 in the outermost effective layer vicinity portion 312 is larger than the area equivalent diameter D90 of the silicon oxide segregation region 80 in the chip middle portion 313.

### Circularity

The circularity of the silicon oxide segregation region 80 will be described. The circularity is calculated for each silicon oxide segregation region 80 based on the area and the circumferential length of the silicon oxide segregation region 80, in other words, the area and the length of the contour, by the following equation. Circularity=4π× (area)/(circumferential length) 2.

In the multilayer ceramic capacitor 1 of the present example embodiment, the relationship of the average area of the regions having a circularity of about 0.8 or less among the plurality of silicon oxide segregation regions 80 in the respective portions is expressed as the outer layer interior portion 311<the chip middle portion 313<the outermost effective layer vicinity portion 312.

The above expression indicates that, for the average area of the silicon oxide segregation regions having a circularity of about 0.8 or less, the average cross-sectional area of the silicon oxide segregation region 80 in the chip middle portion 313 is larger than the average cross-sectional area of the silicon oxide segregation region 80 in the outer layer interior portion 311, and the average cross-sectional area of the silicon oxide segregation region 80 in the outermost effective layer vicinity portion 312 is larger than the average cross-sectional area of the silicon oxide segregation region 80 in the chip middle portion 313. The average area of the silicon oxide segregation regions 80 having a circularity of about 0.8 or less in each portion having the above-mentioned relationship indicates that the silicon oxide segregation regions 80 having cross-sectional shapes of not perfectly circular shape but also deformed shape have the above-mentioned relationship. The deformed silicon oxide segregation region 80 is more likely to improve adhesive force than the true circle silicon oxide segregation region 80. Therefore, when the average area of the silicon oxide segregation region 80 having a circularity of about 0.8 or less in each portion satisfies the above-described relationship, the adhesive force is improved between the effective layer portion 10 and the main surface-side outer layer portion 11 where otherwise layer peeling is likely to occur therebetween, and thus the generation of layer peeling between the effective layer portion 10 and the main surface-side outer layer portion 11 can be reduced or prevented. It is preferable that at least the average cross-sectional area of the silicon oxide segregation region 80 in the outermost effective layer vicinity portion 312 is larger than the average cross-sectional area of the silicon oxide segregation region 80 in the chip middle portion 313.

### Method of Manufacturing Multilayer Ceramic Capacitor

An example of a method of manufacturing a multilayer ceramic capacitor according to an example embodiment of the present invention will be described. The method of manufacturing the multilayer ceramic capacitor is not limited to the following method.

A dielectric sheet for manufacturing the dielectric layer 20 and an electrically conductive paste for manufacturing the internal electrode layer 30 are prepared. Both of the dielectric sheet for manufacturing the dielectric layer 20 and the electrically conductive paste for manufacturing the internal electrode layer 30 include a binder and a solvent. The binder and the solvent may be known. Examples of a paste made of an electrically conductive material include a paste obtained by adding an organic binder and an organic solvent to a metal powder.

An electrically conductive paste for manufacturing the internal electrode layer 30 is printed on the dielectric sheet using a printing plate designed to have the shape of the internal electrode layer 30. Examples of printing methods include screen printing and gravure printing. A dielectric sheet having a pattern of the first internal electrode layer 31 and a dielectric sheet having a pattern of the second internal electrode layer 32 is thus prepared.

By laminating a predetermined number of dielectric sheets on which patterns of the internal electrode layers 30 are not printed, a portion to be the first main surface-side outer layer portion 12 adjacent to the first main surface 3 is formed. The dielectric sheet on which the pattern of the first internal electrode layer 31 is printed and the dielectric sheet on which the pattern of the second internal electrode layer 32 is printed are sequentially and alternately laminated thereon to form a portion to be the effective layer portion 10. A predetermined number of dielectric sheets on which patterns of the internal electrode layers 30 are not printed are laminated on the portion defining and functioning as the effective layer portion 10 to form a portion functioning as the second main surface-side outer layer portion 13 adjacent to the second main surface 4. Thus, a multilayer sheet is obtained.

Here, by adjusting the amount of silicon added to the dielectric sheet, the segregation amount of the silicon oxide can be adjusted to a desired value. In order to adjust the amount of silicon added to the dielectric sheet, for example, the amount of silicon added to the outer layer sheet of the outer layer interior portion in the dielectric sheet is changed. For example, when the addition amount of silicon is reduced, the area of segregation of silicon oxide can be reduced. Conversely, when the addition amount of silicon is increased, the segregation area of the silicon oxide can be increased.

Further, in the dielectric sheet, the amount of silicon added to the inner layer sheet of the chip middle portion is changed. For example, when the addition amount of silicon is increased, the area of segregation of silicon oxide can be increased.

In the outermost effective layer vicinity portion as well, the amount of silicon added to the dielectric sheet in the outermost effective layer vicinity portion may be changed in the same or similar manner as in the outer layer interior portion and the chip middle portion center portion. However, with regard to segregation of the silicon oxide in the outermost effective layer vicinity portion, the amount of segregation of the silicon oxide can be increased by discharging silicon included in the outer layer sheet in addition to silicon included in the inner layer sheet to the inner layer side during firing. Therefore, for the outermost effective layer vicinity portion, even when the amount of silicon added to the dielectric sheet of the outermost effective layer vicinity portion is not changed, the amount of segregation of silicon oxide can be adjusted.

Next, the multilayer sheet is pressed in the height direction by, for example, a hydrostatic press or the like to prepare a multilayer block.

Next, the multilayer block is cut into a predetermined size and divided into a plurality of multilayer chips. Thereafter, each of the multilayer chips may be polished by, for example, barrel polishing or the like to round the corner portions and the ridge portions.

Next, the multilayer chips are fired to obtain the multilayer body 2. The firing temperature at this time depends on the materials of the dielectric layer 20 and the internal electrode layer 30, but is preferably, for example, about 900° C. or more and about 1400° C. or less. In particular, by firing the multilayer chip at a temperature of about 1100° C. or more and about 1300° C. or less in an oxidizing atmosphere, it becomes easy to adjust the segregation amount of the silicon oxide to a desired value. As the amount of hydrogen decreases, it becomes a stronger oxidizing atmosphere, and when firing is performed under a stronger oxidizing atmosphere, the segregation of silicon tends to increase. The firing time can be, for example, about 10 hours or more and about 50 hours or less. Further, the temperature rising rate can be, for example, about 1 degree/min or more and about 20 degrees/min or less. The firing time and the temperature rising rate are values when firing in, for example, a batch firing furnace is assumed. The firing method is not limited to a method using the batch firing furnace. Generally, the segregation of silicon tends to increase when the firing time is long and the temperature rising rate is slow.

An electrically conductive paste defining and functioning as the base electrode layer 50 is applied to both end surfaces of the multilayer body 2. In the present example embodiment, the base electrode layer 50 is a fired layer. The fired layer can be formed by, for example, applying an electrically conductive paste including a glass component and a metal to the multilayer body 2 by a method such as dipping, and then performing the firing treatment. The temperature of the firing treatment at this time is preferably, for example, about 700° C. or more and about 900° C. or less.

The multilayer chip before firing and the electrically conductive paste applied to the multilayer chip may be fired simultaneously. In this case, the fired layer is preferably formed by firing a ceramic material added instead of the glass component. At this time, as the ceramic material to be added, it is preferable to use the same kind of ceramic material as that of the dielectric layer 20. In this case, an electrically conductive paste is applied to the multilayer chip before firing, and the multilayer chip and the electrically conductive paste applied to the multilayer chip are fired at the same time to form the multilayer body 2 in which the fired layer is formed.

Then, a plated layer is formed on the surface of the base electrode layer 50 made of the fired layer. In the present example embodiment, the first plated layer 71 is formed on the surface of the first base electrode layer 51. A second plated layer 72 is formed on the surface of the second base electrode layer 52. In the present example embodiment, for example, a nickel plated layer and a tin plated layer are formed as the plated layers. In the plating treatment, either electrolytic plating or electroless plating may be used. However, the electroless plating requires a pretreatment using a catalyst or the like in order to improve the plating precipitation rate, and therefore, there is a disadvantage in that the process becomes complicated. Therefore, it is usually preferable to use electrolytic plating. The nickel plated layer and the tin plated layer are sequentially formed by, for example, barrel plating.

When the electrically conductive resin layer is provided, the electrically conductive resin layer may cover the fired layer. When the electrically conductive resin layer is provided, an electrically conductive resin paste including, for example, a thermosetting resin and a metal component is applied on the fired layer, and then heat-treated at a temperature from, for example, about 250° C. to about 550° C. or more. Thus, the thermosetting resin is thermally cured to form the electrically conductive resin layer. The atmosphere during the heat treatment is preferably an N₂ atmosphere, for example. In order to prevent scattering of the resin and to prevent oxidation of various metal components, the oxygen concentration is preferably, for example, about 100 ppm or less.

The multilayer ceramic capacitor 1 is manufactured by the manufacturing process described above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers and a plurality of laminated internal electrode layers, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an effective layer portion including the plurality of dielectric layers and the plurality of internal electrode layers that are alternately laminated, and outer layer portions that sandwich the effective layer portion in the height direction;
a first external electrode on the first end surface; and
a second external electrode on the second end surface;
wherein
the multilayer body further includes:
an outer layer interior portion inside one of the outer layer portions;
an outermost effective layer vicinity portion, which is closest to one of the outer layer portions, in the effective layer portion;
a chip middle portion in a middle portion of the multilayer body; and
a plurality of silicon oxide segregation regions; and
in a cross section of the multilayer body in a plane parallel or substantially parallel to the width direction and the height direction, a relationship of average cross sectional areas of a plurality of silicon oxide segregation regions in respective portions of the outer layer interior portion, the chip middle portion, and the outermost effective layer vicinity portion is expressed as:
the outer layer interior portion<the chip middle portion<the outermost effective layer vicinity portion.

2. The multilayer ceramic capacitor according to claim 1, wherein a relationship of values of an area equivalent diameter of the plurality of silicon oxide segregation regions in the respective portions of the outer layer interior portion, the chip middle portion, and the outermost effective layer vicinity portion is expressed as:
the outer layer interior portion<the chip middle portion<the outermost effective layer vicinity portion.

3. The multilayer ceramic capacitor according to claim 1, wherein a relationship of an average cross sectional area of cross sections of the multilayer body in a plane parallel or substantially parallel to the width direction and the height direction at portions having a circularity of about 0.8 or less among the plurality of silicon oxide segregation regions in the respective portions of the outer layer interior portion, the chip middle portion, and the outermost effective layer vicinity portion is expressed as:
the outer layer interior portion<the chip middle portion<the outermost effective layer vicinity portion.

4. The multilayer ceramic capacitor according to claim 1, wherein the multilayer body has a rectangular or substantially rectangular parallelepiped shape.

5. The multilayer ceramic capacitor according to claim 1, wherein a dimension in the length direction of the multilayer body is about 0.2 mm or more and about 6 mm or less, a dimension in the height direction of the multilayer body is about 0.05 mm or more and about 5 mm or less, and a dimension of the multilayer body in the width direction is about 0.1 mm or more and about 5 mm or less.

6. The multilayer ceramic capacitor according to claim 1, wherein each of the plurality of dielectric layers includes barium titanate, calcium titanate, strontium titanate, or calcium zirconate as a main component.

7. The multilayer ceramic capacitor according to claim 6, wherein each of the plurality of dielectric layers includes a manganese compound, an iron compound, a copper compound, a cobalt compound, or a nickel compound as a subcomponent.

8. The multilayer ceramic capacitor according to claim 1, wherein a thickness of each of the plurality of dielectric layers is about 0.2 μm or more and about 10 μm or less.

9. The multilayer ceramic capacitor according to claim 1, wherein a number of the plurality of dielectric layers is 15 or more and 1200 or less.

10. The multilayer ceramic capacitor according to claim 1, wherein each of the plurality of internal electrode layers includes nickel, copper, silver, palladium, or gold, or an alloy including at least one of nickel, copper, silver, palladium, or gold.

11. The multilayer ceramic capacitor according to claim 1, wherein a thickness of each of the plurality of internal electrode layers is about 0.2 μm or more and about 2.0 μm or less.

12. The multilayer ceramic capacitor according to claim 1, wherein a number of the plurality of internal electrode layers is 15 or more and 1000 or less.

13. The multilayer ceramic capacitor according to claim 1, wherein
the first external electrode extends from the first end surface to portions of each of the first and second main surfaces and each of the first and second lateral surfaces; and
the second external electrode extends from the first end surface to portions of each of the first and second main surfaces and each of the first and second lateral surfaces.

14. The multilayer ceramic capacitor according to claim 1, wherein
the first external electrode includes a first base electrode layer and a first plated layer; and
the second external electrode includes a second base electrode layer and a second plated layer.

15. The multilayer ceramic capacitor according to claim 14, wherein each of the first and second base electrode layers is a fired layer.

16. The multilayer ceramic capacitor according to claim 15, wherein the fired layer includes a metal component and at least one of a glass component and a ceramic component.

17. The multilayer ceramic capacitor according to claim 16, wherein the metal component includes at least one of one of copper, nickel, silver, palladium, an alloy of silver and palladium, or gold.

18. The multilayer ceramic capacitor according to claim 15, wherein the glass component includes at least one of boron, silicon, barium, magnesium, aluminum, or lithium.

19. The multilayer ceramic capacitor according to claim 15, wherein the ceramic component includes at least one of barium titanate, calcium titanate, a mixed crystal material obtained by replacing a portion of the barium of barium titanate with calcium, strontium titanate, or calcium zirconate.

20. The multilayer ceramic capacitor according to claim 14, wherein a thickness of each of the first and second base electrode layers is about 10 μm or more and about 200 μm or less.
